(19) United States
(12) Patent Application Publication
(10) Pub. No.: US 2002/0066227 A1
(43) Pub. Date: Jun. 6, 2002

(54) Method and tray for propagating and planting collections of flowers or plants

(76) Inventor: Caren Wood-Phillips, Delaware, OH (US)

Correspondence Address: STANDLEY & GILCREST LLP, 495 METRO PLACE SOUTH, SUITE 210, DUBLIN, OH, 43017, US

(21) Appl. No.: 09/728,156

(22) Filed: Dec. 1, 2000

(51) Int. Cl. A01G 9/02

(52) U.S. Cl. 47/66.5

(57) ABSTRACT

The present invention includes a method of growing collections of flowers or plants, the method comprising the steps of propagating the collection of flowers or plants in a multiple cavity tray, wherein the tray comprises multiple individual cavities integral to the tray for receiving one or more flowers or plants of one or more varieties, removing the collection of flowers or plants, and planting the collection of flowers or plants.

Additionally the present invention is for a multiple cavity tray for a collection of flowers or plants, wherein the multiple cavity tray is used in the propagation and transport of the flowers or plants, the tray comprising: multiple individual cavities integral to the tray for receiving one or more flowers or plants of one or more varieties, containing at least one removal hole located in the center of each of the multiple individual cavities; and, containing a plurality of drainage holes in each of the multiple individual cavities. The tray of the present invention may additionally comprise a “lip” for the attachment of signage (information card and/or information tag).

### TECHNICAL FIELD OF THE INVENTION

The present invention is in the field of plant and flower propagation and planting.

### BACKGROUND AND SUMMARY OF THE INVENTION

At the retail level, plants are sold in containers (pots) from which the consumer removes the plant from the pot and plants in their garden. Plants are sold various sizes of plastic containers:

Cell packs—vegetables, annuals (plants that die each year)

One quart—annuals, perennials (plants that don't die each year and come back)

Two-quarts—perennials

One gallon and up—perennials, shrubs, trees

Bowls/hanging baskets—annuals

The cell packs, one and two quart containers generally are transported from the grower to the retailer in separate, plastic trays. The trays can hold 4, 6 or 8 cell packs, 8, 10, 12, 15 quart containers, or 8 2-quart containers. The customer may purchase an entire tray of potted plants or a single potted plant from the tray. Typically, when every pot in the tray has been purchased, the retailer will discard tray.

At the retail level, most plants are displayed by type (annuals, vegetables, herbs, perennials, shrubs and trees), then by variety (marigolds, tomatoes, basil, coneflowers, junipers, and maples). Homeowners typically purchase individual plants or in quantities to augment an existing landscape. If the homeowner has in mind a plan for his garden that includes specific perennial plants that would be planted in a group, at this time, the only known option is to buy each plant in an individual pot.

Many consumers want the “look” and success of a professional perennial garden they see in their neighbors' landscape, in magazines or on TV, but don't know what plant selections to make at the retail store to achieve that look. To satisfy that need, a trend in home gardening available only through mail order sources, is perennial garden collections. The present invention is to pre-selected perennials intended to be planted together in a group for aesthetic appeal, chosen for a specific sight (sun, shade) or theme (attracting hummingbirds, butterflies) complete with care instructions, “plant by number” diagram and tags. Mail order companies sell their collections as bare-root plants (no pot) or in individual pots shipped to the consumers′ home.

At the present time, there are no known perennial collections being sold or displayed at the retail level with the method or tray of the present invention. Etera “bundles” individual potted plants together either by placing them in a crate or a basket. There are collection information cards in a separate display and if the consumer likes a particular collection idea, they may purchase the crate or basket containing the individual pots. Components are available for the consumer and by color-coding individual pots, they are able to select plants that create a theme or special look.

The present invention's collection may be comprised of 15 quart size perennials contained in one tray without individual pots. The reasons for selling these collections as a unit and not by individual pots is ease for the consumer (an entire garden in one tray), reduction in growers costs and, elimination of the possibility of a consumer taking a plant from the tray and thus negating its value as a collection at the retail level.

There is one presently known manufacturer that makes a tray that is specifically designed to hold plants (roots and soil only). One way to tell that this tray is designated as a propagation tray and not a transport tray for individual pots is that the holes in the bottom are designed for proper drainage. (A transport tray has drainage holes, or slots, but not as many). The tray of the present invention may have similar drainage holes but may have a larger hole in the center, for the customer to “pop” the plant out of the cavity with their finger. The tray of the present invention may be larger than those previously sold, may be custom designed for quart-sized plants and may have a “lip” larger than other trays. The lip is designed for ease of handling and for the insertion of signage (information card or information tag). Other trays, known to be in use, are marketed for propagating (growing) one variety of plant per tray (i.e. geraniums) and are not known to be used at the retail level for any configuration of plants, either the same variety or different varieties in a theme-based product such as the present invention.

There are different propagation methods for perennials. All methods are standard practice in the industry. The perennials of the present invention may be propagated in any of the following manner:

1) Some collection perennials are started by sowing seeds directly into (plug trays) filled with specially formulated propagation mix. The propagation trays have variable cavity sizes depending on the variety of perennial grown. Cavity quantities per tray can range from 32, 72, 98, 125, 305. (The higher the number, the smaller the cavity). Once the seeds germinate, (sprout leaves) and develop sufficient roots, the individual plants are considered “plugs” and are transplanted (or “plugged”) into larger containers, to continue rooting out either by hand or mechanical means. The collection perennials of the present invention started by seed will be “finished” or plugged either directly into the tray cavity for further rooting and into round pots corresponding to the circumference of the tray cavity as a back-up plant in the event we have to switch out a “bad” plant with a good one prior to delivering to the retailer.

2. Other collection perennials will be vegetatively-propagated, meaning, a stem tip of a “mother” plant will be cut, placed in a-propagation mix and tray and root Again once the cutting has developed roots, it will be treated as a plug and plugged either directly into the tray, or round pot. (For some varieties of perennials this method is the only way to reproduce a perennial and in some cases, a preferred method).

3. Some collection perennials will be grown by other growers and the other growers will propagate and finish in the size of plug needed and will ship them to the grower who is selling to the retailer. These plugs will be either planted directly in the tray or in the round pots, depending on its growing needs.

4. Some collection perennials plants are “divisions” of other mother plants, meaning, the large plant has been divided down to its smaller divisions and planted in round pots. The plant will then be popped out of its pot and placed in the collection tray cavity when it's ready.

The present invention may be practiced with a non-automated method (hand planted trays) or an automated method. Automating the collection process may consist of plugging the trays by machine, but may have to be configured for one collection tray to run through the process several times to receive the different plant varieties.

The present invention includes a method of growing a collection of flowers or plants, the method comprising the steps of propagating the collection of flowers or plants in a multiple cavity tray, wherein the tray comprises multiple individual cavities integral to the tray for receiving one or more flowers or plants of one or more varieties, removing the collection of flowers or plants, and planting the collection of flowers or plants.

Additionally, the present invention includes a multiple cavity tray for a collection of flowers or plants, wherein the multiple cavity tray is used in the propagation and transport of the flowers or plants, the tray comprising: multiple individual cavities integral to the tray for receiving one or more flowers or plants of one or more varieties, containing at least one removal hole located in the center of each of the multiple individual cavities; and, containing a plurality of drainage holes in each of the multiple individual cavities.

The tray of the present invention additionally may have affixed to it an information card or information tag. The information tag may contain the name of the flower or plant, a picture of the flower or plant, growing and/or planting suggestions, and a number assigned to the flower or plant that corresponds to the planting guide. The information card may have printed information on both or either sides of the card. The information card may contain any information useful in the planting and growing of the plants and flowers. The information contained on the card may be pictures of the flowers or plants in the collection, a picture of the collection when completely planted, a planting guide showing what flowers or plants are planted where, names of the flowers or plants and planting tips.

### BRIEF DESCRIPTION OF THE DRAWINGS

FIG. 1 shows a top view of a multiple cavity tray, in accordance with one embodiment of the present invention.

FIG. 2 shows a side view of a multiple cavity tray, in accordance with one embodiment of the present invention.

FIG. 3 shows a section view of a multiple cavity tray, in accordance with one embodiment of the present invention.

FIG. 4A shows the front side of the information card, in accordance with one embodiment of the present invention.

FIG. 4B shows the back side of the information card, in accordance with one embodiment of the present invention.

FIG. 5 shows an information tag, in accordance with one embodiment of the present invention.

### DETAILED DESCRIPTION OF THE PREFERRED EMBODIMENTS

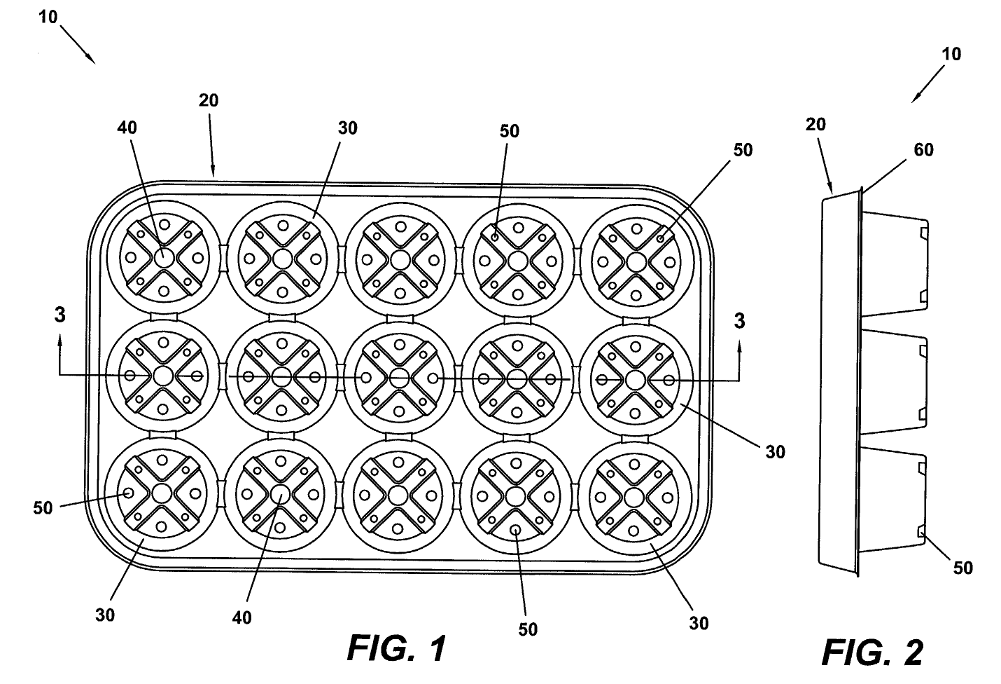

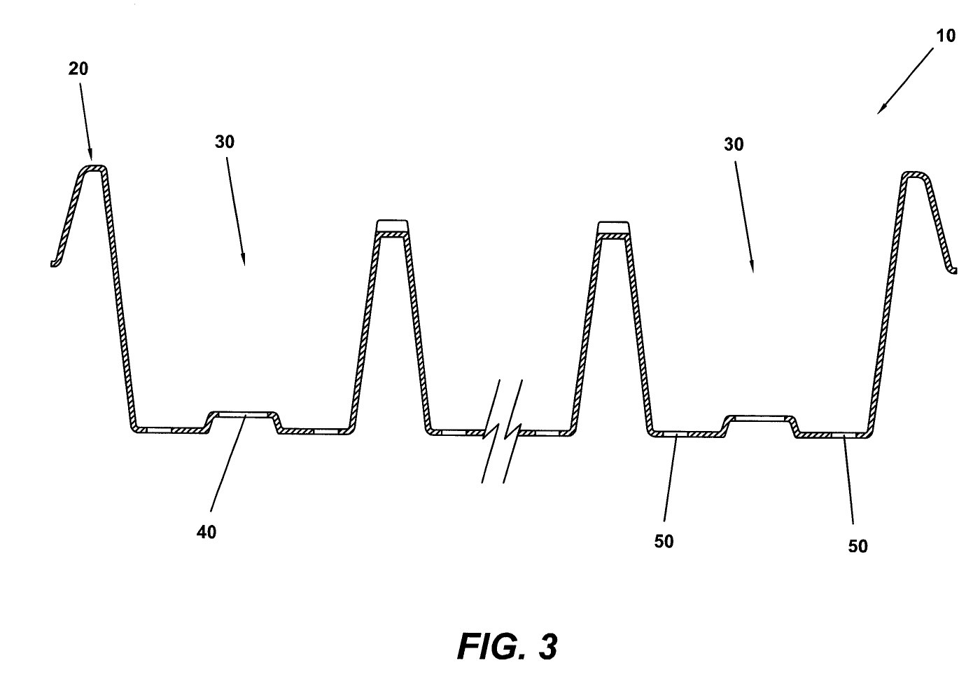

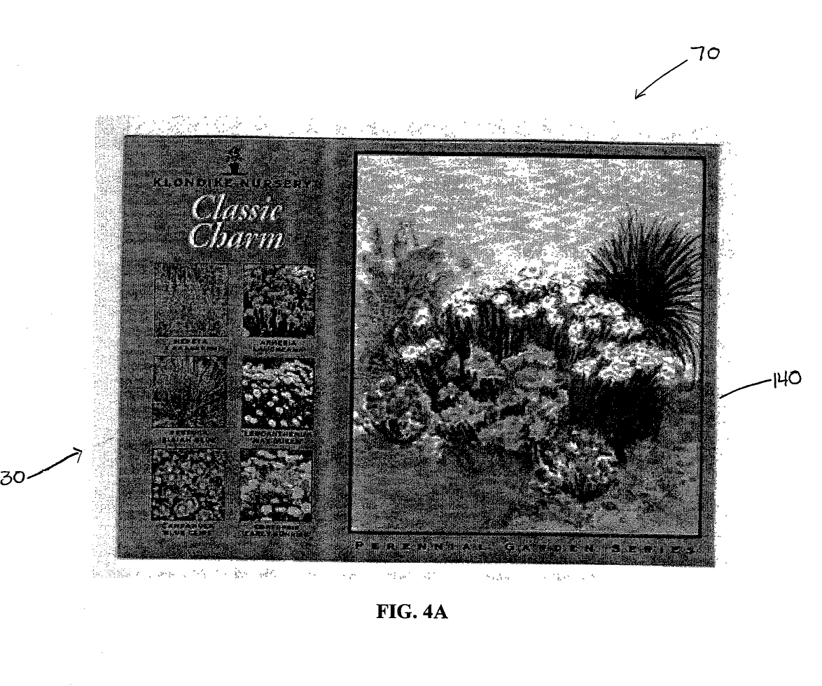

In accordance with the foregoing summary, the following presents a detailed description of the preferred embodiment of the invention that is currently considered to be the best mode. One embodiment of the multiple cavity tray can be observed by reference to FIGS. 1-3.

The present invention is to a method of growing a collection of flowers or plants, the method comprising the steps of propagating the collection of flowers or plants in a multiple cavity tray 20, wherein the tray comprises multiple individual cavities 30 integral to the tray for receiving one or more flowers or plants of one or more varieties, removing the collection of flowers or plants, and planting the collection of flowers or plants.

Additionally the invention includes a multiple cavity tray 20 for a collection of flowers or plants, wherein the multiple cavity tray 20 is used in the propagation and transport of the flowers or plants, the tray comprising: multiple individual cavities 30 integral to the tray for receiving one or more flowers or plants of one or more varieties, containing at least one removal hole 40 located in the center of each of the multiple individual cavities; and, containing a plurality of drainage holes 50 in each of the multiple individual cavities 30.

The tray of the present invention may be larger than those previously sold and may have a “lip” 60 larger than other trays. The “lip” 60 is designed for ease of handling and for the insertion of signage (information card or information tag).

A collection of flowers and plants is meant to include any from the group consisting of perennial flowers, perennial plants, annual flowers, annual plants, or herbs.

The flowers or plants of the present invention may be propagated by any known or acceptable method. Preferably by a method selected from the group consisting of sowing seed, vegetatively propagating, plugging, dividing and transplanting and mixtures thereof.

The multiple cavity tray is made of any acceptable material and is preferably plastic and most preferably, polystyrene.

The individual cavities of the multiple cavity tray can be any size but are preferably in the range of ½ to 5 quart size and most preferably in the 1-quart size.

The number of individual cavities can vary depending on the number of plants or flowers in the collection of flowers or plants being planted. Preferably the number of cavities ranges from 4 to 24 and most preferably 15.

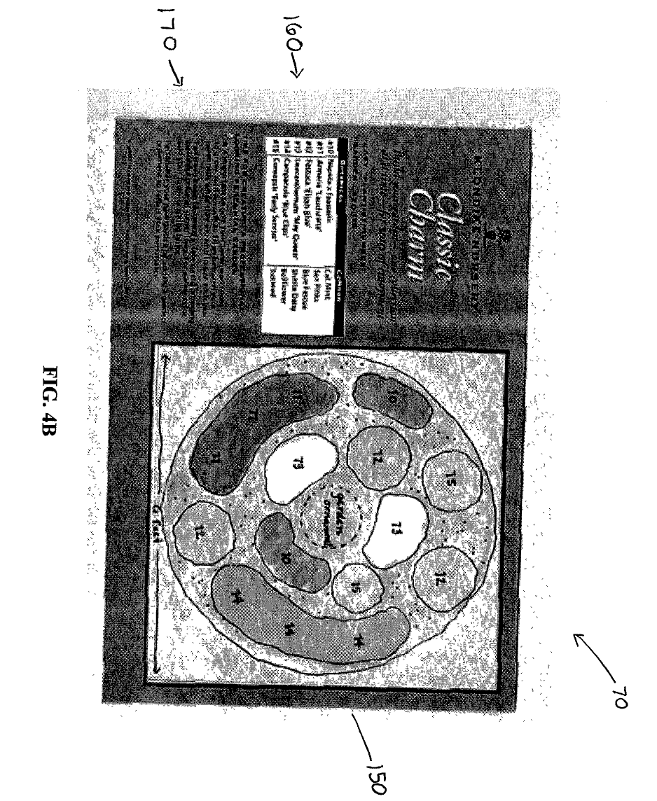

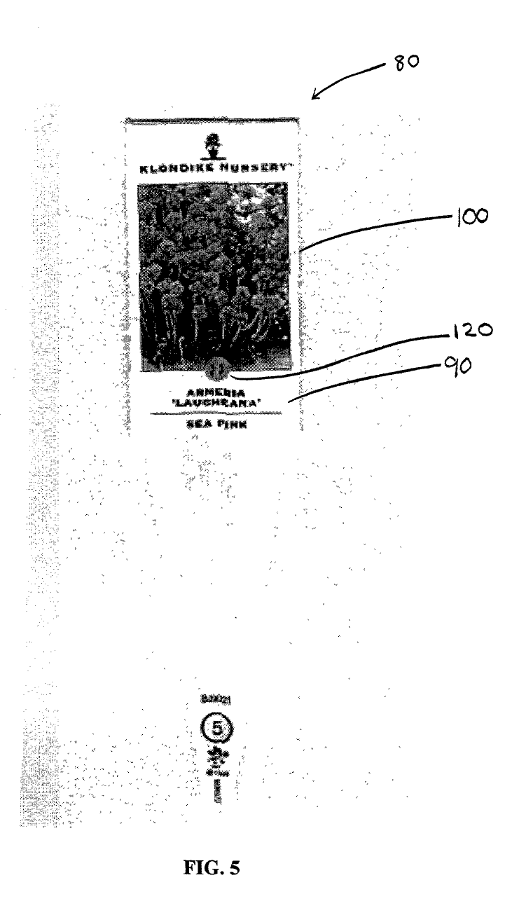

According to FIGS. 4A, 4B and 5, the tray of the present invention additionally may have a “lip” used for attaching at least one signage selected from the group consisting of an information card 70 and an information tag 80. The information card 70 may have printed information on both or either sides of the card. The information card 70 may contain any information useful in the planting and growing of the plants and flowers. The information contained on the card may be pictures of the flowers or plants in the collection 130, a picture of the collection when completely planted 140, a planting guide 150 showing what flowers or plants are planted where, names of the flowers or plants 160 and planting tips 170. The information tag 80 may contain the name of the flower or plant 90, a picture of the flower or plant 100, growing and planting suggestions (such as whether a sun or shade plant and how far apart to plant), and a number assigned to the flower or plant 120 that corresponds to the planting guide 150 (see FIG. 4B) and to the list of all flowers and plants in the collection 160 (see FIG. 4B).

The method of propagating the collection of flowers or plants may be a non-automated or automated process. If automated, the tray would most likely need to be run through a mechanical trasplanter several times in order to receive the different varities of plants or flowers.

The preferred embodiments herein disclosed are not intended to be exhaustive or to unnecessarily limit the scope of the invention. The preferred embodiments were chosen and described in order to explain the principles of the present invention so that others skilled in the art may practice the invention. Having shown and described preferred embodiments of the present invention, it will be within the ability of one of ordinary skill in the art to make alterations or modifications to the present invention, such as through the substitution of equivalent materials or through the use of equivalent method steps, so as to be able to practice the present invention without departing from its spirit as reflected in the appended claims, the text and teaching of which are hereby incorporated by reference herein. It is the intention, therefore, to limit the invention only as indicated by the scope of the claims and equivalents thereof.

What is claimed is:

1. A method of growing a collection of flowers or plants, the method comprising the steps of:
a) propagating said collection of flowers or plants in a multiple cavity tray, wherein said tray comprises multiple individual cavities integral to said tray for receiving one or more flowers or plants of one or more varieties;
b) removing said collection of flowers or plants; and,
c) planting said collection of flowers or plants.

2. The method of claim 1 wherein the propagation is an automated or non-automated process.

3. The method of claim 1 wherein said collection of flowers or plants are selected from the group consisting of perennial flowers, perennial plants, annual flowers, annual plants, or herbs.

4. The method of claim 1 wherein said tray is comprised of plastic.

5. The method of claim 1 wherein said collection may be propagated by a method selected from the group consisting of sowing seeds, vegetatively propagating, plugging, dividing, and transplanting and mixtures thereof.

6. The method of claim 1 wherein said cavity is 1-quart size.

7. The method of claim 1 wherein the number of said multiple individual cavities is 15.

8. A multiple cavity tray for a collection of flowers or plants, wherein said multiple cavity tray is used in the propagation and transport of said flowers or plants, said tray comprising multiple individual cavities integral to said tray for receiving one or more flowers or plants of one or more varieties; containing at least one removal hole located in the center of each of said multiple individual cavities; and, containing a plurality of drainage holes in each of said multiple individual cavities.

9. The tray of claim 8 wherein said tray is comprised of plastic.

10. The tray of claim 8 wherein said cavity is 1-quart size.

11. The tray of claim 8 wherein the number of said mutiple individual cavities is 15.

12. The tray of claim 8 wherein said tray further comprises a lip for the attachment of at least one signage selected from an information card and an information tag.
